(19) United States
(12) Patent Application Publication
(10) Pub. No.: US 2018/0335135 A1
(43) Pub. Date: Nov. 22, 2018

(54) AUTOMATIC TRANSMISSION PERFORMANCE IMPROVEMENTS BY MEANS OR ADAS SENSOR DATA AGGREGATION, V2X INFRASTRUCTURE, AND/OR TIMERS TO DEFER UP-SHIFT DURING DE-ACCELERATION

(71) Applicant: Panasonic Automotive Systems Company of America, Division of Panasonic Corporation of North America, PEACHTREE CITY, GA (US)

(72) Inventor: ERIC SHUFRO, PEACHTREE CITY, GA (US)

(73) Assignee: Panasonic Automotive Systems Company of America, Division of Panasonic Corporation of North America

(21) Appl. No.: 15/981,939

(22) Filed: May 17, 2018

Related U.S. Application Data
(60) Provisional application No. 62/508,193, filed on May 18, 2017.

(51) Int. Cl. F16H 61/16; B60W 10/10; F16H 59/44; F16H 61/21

(52) U.S. Cl. CPC F16H 61/16; B60W 10/10; H04W 4/44; F16H 61/21; F16H 59/44

(57) ABSTRACT

A motor vehicle includes an electronic processor communicatively coupled to an accelerator pedal, a transmission system, and vehicle sensors. The electronic processor detects a driver of the motor vehicle ceasing to depress the accelerator pedal. Dependent upon signals the electronic processor receives from the vehicle sensors, the processor inhibits the transmission system from changing gears in response to the driver ceasing to depress the accelerator pedal.

### CROSS-REFERENCED TO RELATED APPLICATIONS

This application claims benefit of U.S. Provisional Application No. 62/508,193 filed on May 18, 2017, which the disclosure of which is hereby incorporated by reference in its entirety for all purposes.

### FIELD OF THE INVENTION

The disclosure relates to an automatic transmission in a motor vehicle, and, more particularly, to an electronically controlled automatic transmission in a motor vehicle.

### BACKGROUND OF THE INVENTION

Electronic controllers for automatic transmissions do not consider traffic conditions or traffic light signals into their shifting algorithm. Consequently, when driven in ‘automatic’ mode, an automatic transmission will typically shift into the highest suitable gear to lower engine RPM's and save fuel when the driver reduces pressure on the accelerator pedal.

Some vehicle transmissions offer a “sport” mode as an alternative to an automatic mode. The sport mode is a manual transmission mode on an automatic transmission which still requires the driver to change gears using electronic controls. A problem, however, is that the sport mode is not fully automatic and requires constant driver input when operating within normal operational limits.

A driving enthusiast with a manual transmission may have a mindset as follows: I am in 3rd gear at 3000 RPM, and so there is ample pulling torque available. The traffic light is red, but will soon be green. I will coast up to the light and remain in 3rd gear. When the light changes, I am going to push on the accelerator pedal, accelerate quickly in 3rd gear and then shift to 4th gear as my speed increases. There will be minimal lag in throttle response since the transmission is already in the correct gear.

In contrast, an automatic transmission in the same scenario typically operates with a “mindset” as follows: I am in 3rd gear. The driver has taken their foot off of the accelerator pedal, and so we are coasting. I will shift up to 4th or 5th gear to lower RPMs and save fuel. Meanwhile, the driver thinks: The light is going to turn green . . . OK, it's green, and so I will press the accelerator hard. The transmission responds with: Shifting required due to the accelerator being pressed hard . . . <time elapses> . . . done.

Ultimately, the driver experiences the lag of two or more unwanted gear changes. The result is a reduced sport driving experience when in automatic mode. The difference between the driver of the manual transmission and the shifting logic of the automatic transmission is purely intuition, something which human operators possess naturally.

### SUMMARY

The present invention may provide a transmission control algorithm which seems to have the above-described intuition by adding additional shift point data, improving the number and types of allowable decisions, and executing those decisions rapidly. All of this may be made possible by today's sensors, computing power and artificial intelligence (AI) algorithms.

The present invention may provide a transmission with a hybrid automatic/sport mode which is fully automatic, but provides the sensation of sport mode driving without the driver having to be engaged with the shifting operations.

In order to accomplish “hybrid sport mode”, additional information may be provided to the transmission as a supplement to existing throttle position, engine RPM, vacuum pressure and other signals. The additional information, in the form of “shift” or “don't shift” signals, may come from vehicle sensor data received from lane departure cameras, collision radar, and V2X (Vehicle-to-Vehicle and/or Vehicle-to-Infrastructure) systems. These systems are capable of determining whether the traffic ahead is flowing or stopped, or whether the traffic light ahead will be red or green at the time of arrival. Using this information, an automatic transmission in ‘hybrid sport mode’ may choose to hold the existing gear when the accelerator pressure is reduced under the premise that the traffic light may soon change to green and quick throttle response is called for.

In one embodiment, the invention comprises a motor vehicle including an electronic processor communicatively coupled to an accelerator pedal, to a transmission system, and to vehicle sensors. The electronic processor detects a driver of the motor vehicle ceasing to depress the accelerator pedal. Dependent upon signals the electronic processor receives from the vehicle sensors, the processor inhibits the transmission system from changing gears in response to the driver ceasing to depress the accelerator pedal.

In another embodiment, the invention comprises a method of operating a transmission in a motor vehicle, including detecting a driver of the motor vehicle ceasing to depress an accelerator pedal of the motor vehicle. Signals from sensors installed in the vehicle are received. Dependent upon the received signals, the transmission system is inhibited from changing gears while the driver continues to avoid depressing the accelerator pedal.

In yet another embodiment, the invention comprises a method of operating a transmission in a motor vehicle, including detecting a driver of the motor vehicle ceasing to depress an accelerator pedal of the motor vehicle. The transmission system is prevented from changing gears for a predetermined time period while the driver continues to avoid depressing the accelerator pedal. The transmission system is permitted to change gears after the predetermined time period, and while the driver continues to avoid depressing the accelerator pedal.

An advantage of the present invention is that it may enable an automatic transmission to perform more like a well-operated manual transmission without acting completely like a manual transmission. The invention may enable the transmission to still behave as an automatic transmission while still retaining some of the characteristics of a manual transmission. These characteristics may be activated and deactivated dynamically depending on real-time conditions. Therefore, the benefits of both transmission types may be harnessed.

### BRIEF DESCRIPTION OF THE DRAWINGS

A better understanding of the present invention will be had upon reference to the following description in conjunction with the accompanying drawings.

FIG. 1 is a block diagram of one embodiment of an automatic transmission control arrangement of the present invention.

FIG. 2 is a flow chart of one embodiment of an automatic transmission control method of the present invention.

FIG. 3 is a flow chart of another embodiment of an automatic transmission control method of the present invention.

FIG. 4 is a flow chart of yet another embodiment of an automatic transmission control method of the present invention.

### DETAILED DESCRIPTION OF THE PREFERRED EMBODIMENTS

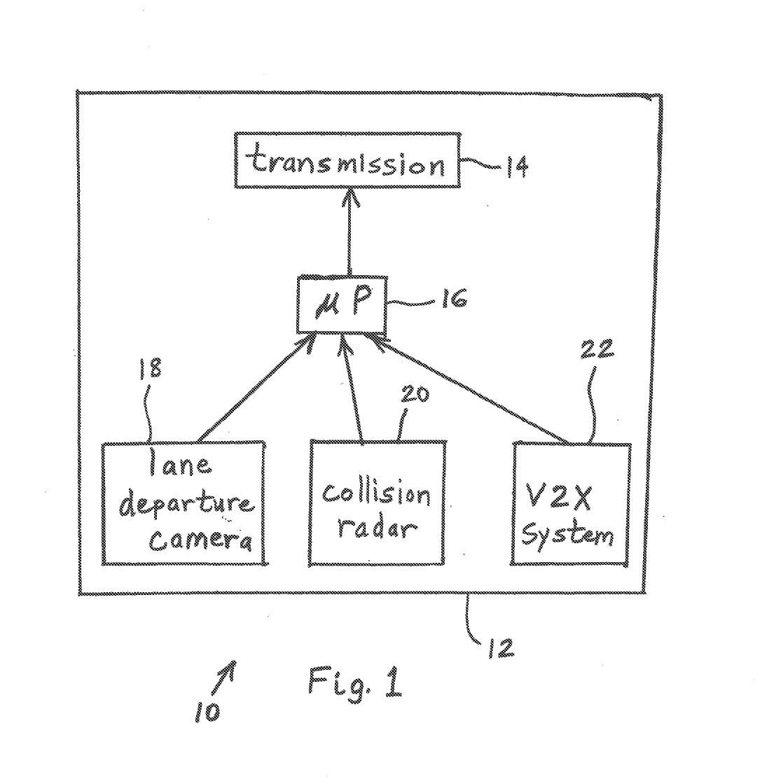

FIG. 1 illustrates one embodiment of an automatic transmission control arrangement 10 of the present invention for a motor vehicle 12, including a transmission 14, an electronic processor 16, and vehicle sensors, such as a lane departure camera 18, an object detection system, such as a collision radar system 20, and a V2X (Vehicle-to-Vehicle and/or Vehicle-to-Infrastructure) system 22. Processor 16 may receive data from sensors 18, 20, 22, and may control the gear shifting of transmission 14 based on this sensor data. For example, when the driver reduces the pressure on the accelerator, processor 16 may prevent upshifting of transmission 14 if lane departure camera 18 indicates that vehicle 12 has recently (e.g., within the past three seconds) changed lanes (and thus is more likely to need to quickly accelerate in the near future); if collision radar system 20 indicates that there are no other vehicles in front of vehicle 12; and/or if V2X system 22 indicates that a red traffic light within a predetermined distance (e.g., within one hundred yards) in front of vehicle 12 will turn green within a predetermined time period (e.g., within four seconds).

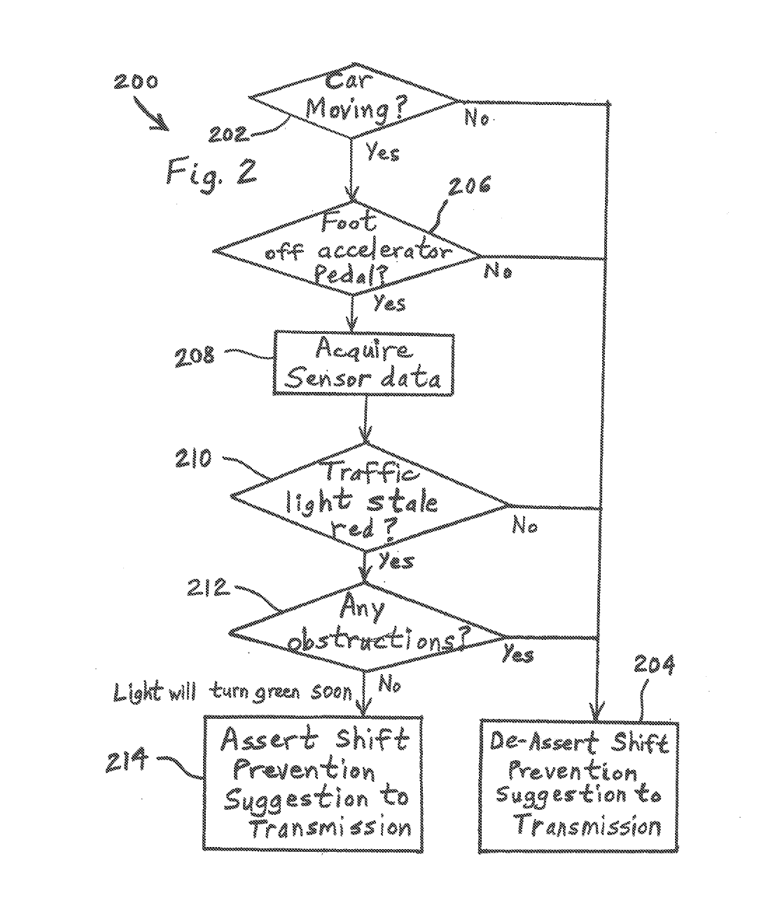

FIG. 2 illustrates one embodiment of an automatic transmission control method 200 of the present invention. In a first step 202, it is determined whether the vehicle including the automatic transmission is moving. For example, a vehicle speedometer may indicate whether the speed of vehicle 12 is nonzero. If it is determined that the vehicle is not moving, then operation proceeds to step 204 where a shift prevention suggestion to transmission 14 is de-asserted. For example, transmission 14 is allowed to operate normally without inhibiting any upshifting by transmission 14.

If it is determined in step 202 that the vehicle is moving, then in step 206 it is determined whether the driver has his foot off of the accelerator pedal. If it is determined in step 206 that the driver is at least partially depressing the accelerator pedal, then operation proceeds to step 204. Conversely, if it is determined in step 206 that the accelerator pedal is not being depressed, then in step 208 vehicle sensor data is acquired. For example, data may be received from collision radar system 20 and V2X system 22.

Next, in step 210, it is determined whether the upcoming traffic light is a stale red. For example, V2X system 22 may indicate whether a red light within a predetermined distance in front of vehicle 12 is scheduled to turn green within a predetermined period of time. If the upcoming traffic light is not a stale red (e.g., will not turn green soon), then operation proceeds to step 204. However, if the upcoming traffic light is a stale red, then in step 212 it is determined whether there are any obstructions in front of vehicle 12. For example, collision radar system 20 may indicate whether any vehicles or other objects are within a predetermined distance in front of vehicle 12, and/or are between vehicle 12 and the traffic light. If there is an obstruction in front of vehicle 12, then operation proceeds to step 204. However, if there is not an obstruction in front of vehicle 12, then in step 214 a shift prevention suggestion to the transmission is asserted. For example, the normal upshifting by transmission 14 when the driver takes his foot off the accelerator is inhibited. Thus, without the upshifting, transmission 14 may enable vehicle 12 to respond faster and/or with less lag when the driver again depresses the accelerator.

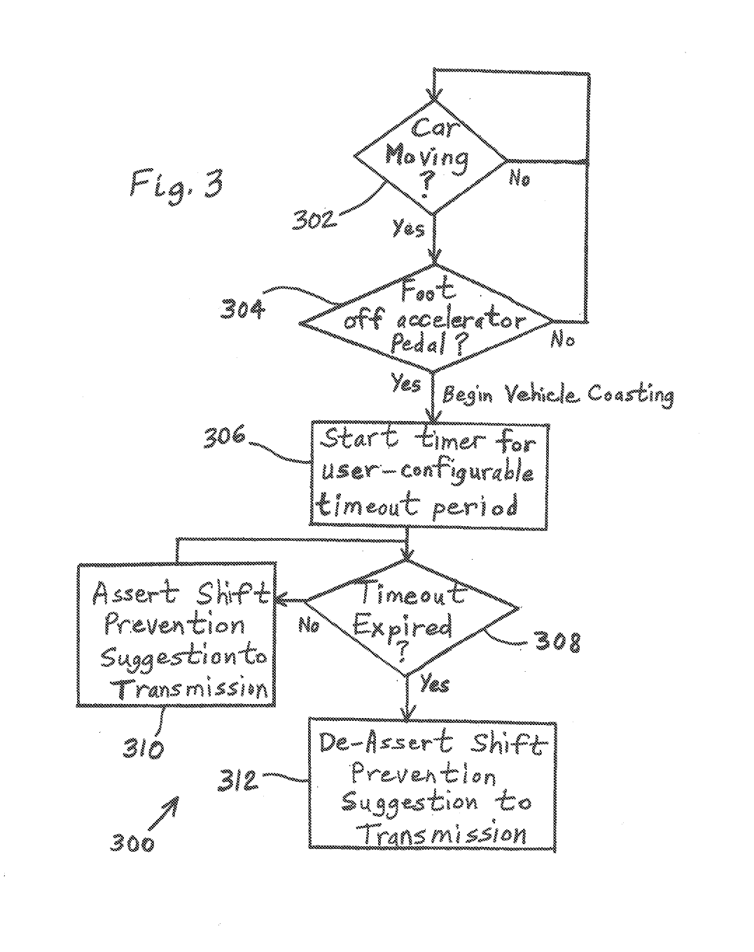

In another embodiment of an automatic transmission control method 300 of the present invention, illustrated in FIG. 3, an upshift blocking timer is implemented in automatic mode to prevent upshift while coasting unless coasting has been occurring for more than a user-configurable number of seconds. This is a reasonably elegant approach with less complexity, but may be overly simplistic in comparison to harnessing the power of modern day car sensors.

In a first step 302, it is determined whether the vehicle that includes the automatic transmission is moving. For example, a vehicle speedometer or global positioning system (GPS) module may indicate whether the speed of vehicle 12 is nonzero. If it is determined that the vehicle is not moving, then operation remains at step 302 until there is car movement.

Once it is determined in step 302 that the vehicle is moving, then in step 304 it is determined whether the driver has his foot off of the accelerator pedal. If it is determined in step 304 that the driver is at least partially depressing the accelerator pedal, then operation returns to step 302. Conversely, if it is determined in step 304 that the accelerator pedal is not being depressed (and perhaps the vehicle has begun coasting), then in step 306 a timer is started for a user-configurable timeout period. For example, the driver may establish a time period of about three seconds of coasting without any upshifting (e.g., from 4th gear to 5th gear) being permitted.

Next, in step 308, it is determined whether the timeout period has expired. For example, the timer may indicate whether the user-configurable timeout period (e.g., three seconds) has expired. If the timeout period has not expired (e.g., it has not yet been three seconds since it was determined that the driver's foot was off the accelerator pedal, and the driver's foot has since remained off the accelerator pedal), then operation proceeds to step 310. In step 310, a shift prevention suggestion to the transmission is asserted. For example, the normal upshifting by transmission 14 when the driver takes his foot off the accelerator is inhibited. Thus, without the upshifting, transmission 14 may enable vehicle 12 to respond faster and/or with less lag when the driver again depresses the accelerator. The inhibiting of upshifting continues until it is determined in step 308 that the timeout period has expired.

After it has been determined that the timeout period has expired, operation proceeds to step 312 where the shift prevention suggestion to transmission 14 is de-asserted. For example, transmission 14 is allowed to operate normally without inhibiting any upshifting by transmission 14.

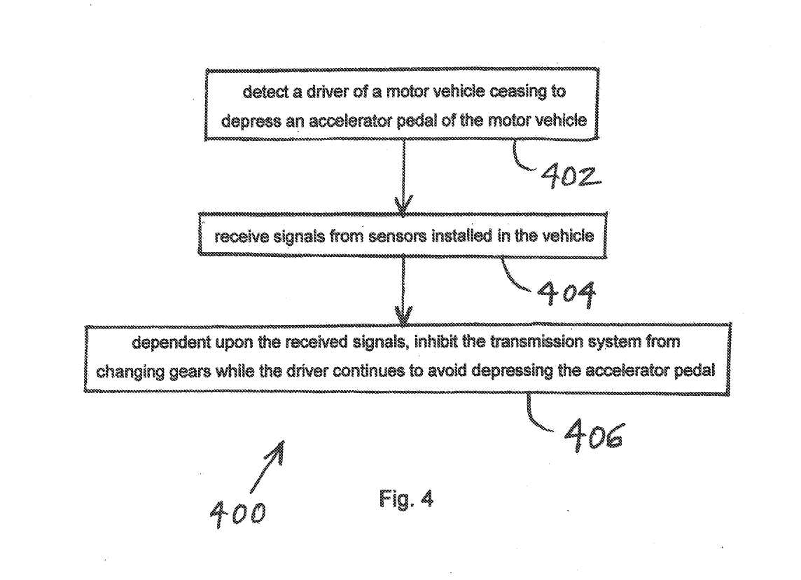

FIG. 4 illustrates yet another embodiment of an automatic transmission control method 400 of the present invention. In a first step 402, it is detected that a driver of the motor vehicle has ceased depressing an accelerator pedal of the motor vehicle. For example, a sensor (not shown) may detect the position of the accelerator pedal.

Next, in step 404, signals are received from sensors installed in the vehicle. For example, lane departure camera 18, collision radar system 20 and V2X system 22 may transmit signals to processor 16.

In a final step 406, dependent upon the received signals, the transmission system is inhibited from changing gears while the driver continues to avoid depressing the accelerator pedal. For example, while there is a reduced level of pressure on the accelerator, processor 16 may prevent upshifting of transmission 14 if lane departure camera 18 indicates that vehicle 12 has recently (e.g., within the past two to four seconds) changed lanes; if collision radar system 20 indicates that there are no other vehicles within 100 feet in front of vehicle 12; and/or if V2X system 22 indicates that a red traffic light within a predetermined distance (e.g., within two hundred yards) in front of vehicle 12 will turn green within a predetermined time period (e.g., within six seconds).

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
an accelerator pedal;
a transmission system;
a plurality of vehicle sensors; and
an electronic processor communicatively coupled to the accelerator pedal, the transmission system, and the vehicle sensors, the electronic processor being configured to:
detect a driver of the motor vehicle ceasing to depress the accelerator pedal; and
dependent upon signals the electronic processor receives from the vehicle sensors, inhibit the transmission system from changing gears in response to the driver ceasing to depress the accelerator pedal.

2. The vehicle of claim 1 wherein one of the vehicle sensors comprises a V2X system, and the electronic processor is configured to inhibit the transmission system from changing gears in response to the driver ceasing to depress the accelerator pedal unless the V2X system indicates that a traffic light is disposed within a predetermined distance in front of the vehicle and the traffic light will continue to be red for at least a predetermined period of time.

3. The vehicle of claim 2 wherein the predetermined distance is approximately between fifty yards and five hundred yards.

4. The vehicle of claim 2 wherein the predetermined period of time is approximately between one second and five seconds.

5. The vehicle of claim 1 wherein one of the vehicle sensors comprises an object detection system, and the electronic processor is configured to inhibit the transmission system from changing gears in response to the driver ceasing to depress the accelerator pedal only if the object detection system indicates that there are no obstructions disposed within a predetermined distance in front of the vehicle.

6. The vehicle of claim 1 wherein one of the vehicle sensors comprises a lane departure detector, and the electronic processor is configured to inhibit the transmission system from changing gears in response to the driver ceasing to depress the accelerator pedal unless the lane departure detector indicates that the vehicle has changed lanes within a previous predetermined period of time.

7. The vehicle of claim 1 wherein the signals that the electronic processor receives from the vehicle sensors include signals from an object detection system and signals from a vehicle-to-infrastructure system.

8. The vehicle of claim 7 wherein the signals that the electronic processor receives from the vehicle sensors include signals from a vehicle movement detector.

9. The vehicle of claim 7 wherein the signals that the electronic processor receives from the vehicle sensors include signals that indicate changes in a direction in which the vehicle is being steered.

10. A method of operating a transmission in a motor vehicle, the method comprising:
detecting a driver of the motor vehicle ceasing to depress an accelerator pedal of the motor vehicle;
receiving signals from sensors installed in the vehicle; and
dependent upon the received signals, inhibiting the transmission system from changing gears while the driver continues to avoid depressing the accelerator pedal.

11. The method of claim 10 wherein one of the vehicle sensors comprises a V2X system, and the transmission system is inhibited from changing gears while the driver continues to avoid depressing the accelerator pedal unless the V2X system indicates that a traffic light is disposed within a predetermined distance in front of the vehicle and the traffic light will continue to be red for at least a predetermined period of time.

12. The method of claim 10 wherein one of the vehicle sensors comprises an object detection system, and the transmission system is inhibited from changing gears in response to the driver ceasing to depress the accelerator pedal only if the object detection system indicates that there are no obstructions disposed within a predetermined distance in front of the vehicle.

13. The method of claim 10 wherein one of the vehicle sensors comprises a lane departure detector, and the transmission system is inhibited from changing gears in response to the driver ceasing to depress the accelerator pedal unless the lane departure detector indicates that the vehicle has changed lanes within a previous predetermined period of time.

14. The method of claim 10 wherein the signals from the sensors include signals from an object detection system and signals from a vehicle-to-infrastructure system.

15. The method of claim 14 wherein the signals from the sensors include signals from a vehicle movement detector.

16. The method of claim 14 wherein the signals from the sensors include signals that indicate changes in a direction in which the vehicle is being steered.

17. A method of operating a transmission in a motor vehicle, the method comprising:
detecting a driver of the motor vehicle ceasing to depress an accelerator pedal of the motor vehicle;
preventing the transmission system from changing gears for a predetermined time period while the driver continues to avoid depressing the accelerator pedal; and
permitting the transmission system to change gears after the predetermined time period, and while the driver continues to avoid depressing the accelerator pedal.

18. The method of claim 17 further comprising detecting that the vehicle is moving, and wherein the transmission system is preventing from changing gears for the predetermined time period while the driver continues to avoid depressing the accelerator pedal and while the vehicle continues to move.

19. The method of claim 17 wherein the predetermined time period is approximately between two seconds and four seconds.

20. The method of claim 17 wherein the step of preventing the transmission system from changing gears includes preventing the transmission system from upshifting to a higher gear.
